(19) United States
(12) Patent Application Publication
(10) Pub. No.: US 2008/0287581 A1
(43) Pub. Date: Nov. 20, 2008

(54) Aqueous Dispersion of Zinc Compound Modified Polymers

(76) Inventors: Kyu-Jun Kim, Chapel Hill, NC (US); Neal D. Rogers, Kansas City, MO (US)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 12/054,995

(22) Filed: Mar. 25, 2008

Related U.S. Application Data
(60) Provisional application No. 60/938,609, filed on May 17, 2007.

(51) Int. Cl. C08K 3/22; C08K 3/10; C08K 5/09

(52) U.S. Cl. 524/301; 524/401; 524/432

(57) ABSTRACT

An aqueous polymer dispersion contains zinc compound-modified polymer. The zinc compound-modified polymer is produced by the incorporation of zinc compound into the acrylic-modified alkyd by mixing at the temperatures of higher than 50° C. The resulting polymer is then dispersed in water by salt formation with a base. The aqueous dispersion of the present invention offers improved coating properties of early water-spot resistance, hardness, ink stain blocking and scrub resistance while demonstrating the viscosity stability.

### CROSS REFERENCE TO RELATED APPLICATION

This application claims priority under 35 U.S.C. § 119(e) to Provisional Patent Application Ser. No. 60/938,609, filed on May 17, 2007, the entire disclosure of which is hereby incorporated by reference.

### FIELD OF THE INVENTION

The present invention relates to a zinc compound modified polymer and its aqueous dispersion. The zinc modified polymer of the invention is produced by the incorporation of zinc compound into the acrylic modified alkyd by mixing at the temperatures of higher than 50° C. The resulting polymer is then dispersed in water by salt formation. The aqueous dispersion of the present invention offers improved coating properties of early water-spot resistance, hardness, ink stain blocking and scrub resistance while demonstrating the viscosity stability.

### BACKGROUND OF THE INVENTION

Due to the recent VOC regulations which restrict the amount of organic solvents liberated from coatings to environment, numerous water-borne polymers have been developed, where water replaces all or a part of organic solvents used in coating. Despite its significant advancement, water-borne technology is still in need of the effective means to enhance the coating performance without resorting to more chemical crosslinking or higher molecular weight, which inevitably lead to higher cost and viscosity respectively.

Zinc compound, especially, zinc oxide, has been widely used in coatings to enhance their performance by blending it to resin dispersions. For example, incorporating zinc oxide in a coatings formulation is known to potentially benefit hiding power, UV resistance, and preventing stain bleed-through. U.S. Pat. No. 4,256,811 describes a coating composition with zinc metal, zinc oxide and molybdenum sulfide, which exhibits lubricating and corrosion resistance properties. U.S. Pat. No. 4,710,404 used both magnesium oxide and zinc oxide as an anti-corrosive agent in a solvent-free coating composition. U.S. Pat. No. 5,266,105 used zinc oxide pigment to improve the performance of antifouling coating composition.

However, in many cases, the interaction between zinc compound and resin dispersion leads to gellation or dramatic viscosity increase. This limits the use of zinc compound in formulating coating, ink and adhesive with certain resin dispersions, despite its numerous benefits.

Several approaches were used to incorporate the zinc compound into coating materials. U.S. Pat. No. 2,904,526 describes a zinc-containing water-base type of coating composition containing at least 2% by weight of a zinc-ammonia-polymer complex. The zinc-ammonia-polymer complex is the product formed when a low molecular weight, carboxyl-containing polymer is combined with aqueous ammonia and with a dissolved and/or dispersed divalent zinc compound of low solubility such as zinc oxide or zinc hydroxide.

U.S. Pat. No. 4,703,071 describes a single package enamel by first dispersing the zinc oxide in a water compatible solvent containing a butylated urea formaldehyde or butylated melamine and adding the dispersed pigment to emulsion. The coating material showed improved viscosity stability and non-setting of the pigment on storage. U.S. Pat. No. 4,339,370 incorporated the zinc ammonium carbonate compound in aqueous emulsion coating composition. The zinc ammonium carbonate compound was prepared by reacting an equimolar amount of ammonium carbonate and ammonium hydrogen carbonate with zinc oxide and ammonia.

The present invention discloses the novel polymer composition with enhanced coating properties produced by incorporating at least 0.1 and up to 5.0 weight percent of zinc compound into the acrylic modified alkyd, at the elevated temperatures of higher than 50° C. The present invention also discloses the aqueous dispersion produced from the above polymer by salt formation with the base.

Since most zinc compound is located in the hydrophobic polymer phase away from the aqueous phase, the dispersion of the present invention demonstrates excellent stability enabling the present invention to be widely utilized for many coating, ink and adhesive applications.

Scanning Electron Microscopy (SEM) and Transmission Electron Microscopy (TEM) studies of the material of current invention fail to detect any metallic particle in a cast film. This confirms that zinc compound does not exist as original particle; instead, transforms to the much smaller size possibly due to its participation in a chemical reaction.

In other observation, acid value is decreased upon the addition of zinc compound during the process suggesting the acid functionality is consumed with the addition of zinc compound.

These observations are strong indication that a chemical interaction, most likely, a complex formation, between the zinc compound with the acid may be present in the polymer of the current invention.

The films drawn down from the zinc compound modified polymer dispersions of the present invention are transparent, free of opaqueness, and the paints prepared with the present invention show excellent gloss value. This highlights the benefits of the current invention, which is the enhancement of the coating properties without sacrificing their film appearance due to uniform distribution of zinc compound throughout the polymer as small enough entity not to interfere with the visible lights.

A chemical interaction between the zinc compound and the acid in the acrylic modified alkyd may serve as the crosslinking point accounting for substantial enhancement in numerous desirable physical properties, such as, hardness, scrub resistance, ink stain blocking and water resistance.

### BRIEF SUMMARY OF THE INVENTION

The invention relates to the acrylic modified alkyd composition comprising at least 0.1 up to 5.0 weight percent of zinc compounds and its aqueous dispersion produced by salt formation between the acid functionality of the polymer and the base.

### DESCRIPTION OF THE INVENTION

Acrylic modified alkyd useful for the invention may be produced by the condensation reaction of the alkyd with the acrylic-modified fatty acid(s) comprising at least one carboxy containing ethylenically unsaturated monomer. Alternatively, acrylic modified alkyd dispersion for the invention may also be produced by the radical polymerization of at least one ethylenically unsaturated monomer and at least one carboxy-containing ethylenically unsaturated monomer in the presence of alkyd.

The incorporation of zinc compound into the acrylic-modified alkyd for the present invention may be accomplished by mixing zinc compound into the polymer at the temperatures higher than 50° C., preferably 60 to 220° C. Subsequently, the resulting polymer may be dispersed in water by mixing with a base for salt formation.

Examples of useful zinc compound for the invention may be, but are not limited to, zinc oxide, zinc nitrophthalate, zinc acetate, zinc fluoride, zinc molydate, zinc linoleate, zinc naphthenate, zinc palmitate, and zinc stearate.

Acrylic modified alkyd useful for the invention may be produced by the condensation reaction of the alkyd with the acrylic modified fatty acid(s) comprising at least one carboxy containing ethylenically unsaturated monomer. Alternatively, acrylic modified alkyd dispersion for the invention may also be produced by the radical polymerization of at least one ethylenically unsaturated monomers and at least one carboxy-containing ethylenically unsaturated monomer at the temperatures of 60-220° C. in the presence of alkyd.

The polymer (acrylic-modified alkyd) composition of the present invention may comprise between 5 to 95 weight percent of alkyd.

Alkyd for the current invention may be produced by the reaction of multifunctional acid compound(s) and/or monofunctional acid compound(s) and multifunctional hydroxyl compound(s) and fatty acid(s) and/or oil(s).

Examples of multifunctional acid compound useful for the current invention may be, but not limited to, phthalic anhydride, isophthalic acid, terephthalic acid, trimellitic anhydride, 5-(soldiosulfo)-isophthalic acid, 1,4-cyclohexyl dicarboxylic acid, adipic acid, maleic anhydride, tetrahydrophthalic anhydride, hexahydrophthalic anhydride, succinic anhydride and succinic acid.

Example of monofunctional acid compound may be, but not limited to, benzoic acid.

Examples of multifunctional hydroxyl compound for the current invention may be, but not limited to, trimethyol propane, pentaerythritol, trimethyol ethane, neopentyl glycol, 2,2,4-trimethyl pentanediol, propylene glycol, hydrogenated disphenol A, 1,4-butanediol, 1,6-hexanediol, dimethylol propionic acid.

Examples of fatty acid useful for the current invention may be, but not limited to, sunflower fatty acid, tall oil fatty acid, liseed oil fatty acid, soybean oil fatty acid, dehydrated castor oil fatty acid, tung oil fatty acid and safflower fatty acid.

Examples of oil useful for the current invention may be, but not limited to, sunflower oil, tall oil, linseed oil, soybean oil, dehydrated castor oil, tung oil and safflower oil.

Acrylic-modified fatty acid(s) for the current invention may be produced by the radical polymerization of at least one ethylenically unsaturated monomer and at least one carboxy-containing ethylenically unsaturated monomer in the presence of fatty acid(s) using radical initiator(s) at the temperatures of 60-220° C.

Examples of radical initiator useful for the radical polymerization in the current invention may be, but not limited to, 2,2-azobisisobutyronitrile, 1,1-azobiscyclohexane carbonitrile, t-butyl peroxy benzoate, t-butyl peroctoate, di-t-amyl peroxide, di-t-butyl peroxide, t-butyl peroxybenzoate.

Examples of ethylenically unsaturated monomers useful for the current invention may be, but not limited to, styrene, vinyl toluene, methyl methacrylate, n-butyl methacrylate, n-butyl acrylate, isobutyl methacrylate, 2-ethyl hexyl acrylate, 2-hydroxy ethyl methacrlate, 2-hydroxy ethyl acrylate, ethyl acrylate, stearyl methacrylate, hydroxy propyl methacrylate, and hydroxy propyl acrylate.

Examples of carboxy-containing ethylenically unsaturated monomer useful for the current invention may be, but not limited to, acrylic acid, methacrylic acid, itaconic acid, fumaric acid and maleic acid.

Acrylic-modified alkyd containing zinc compound for the current invention may be dispersed in water by the salt formation between the acid functional group from polymer and a base.

Examples of base useful for the current invention may be, but not limited to, ammonia, triethyl amine, n-methyl morpholine, sodium hydroxide, lithium hydroxide, lithium hydroxide monohydrate and n,n-dimethyl ethanol amine.

The aqueous dispersion of the present invention offers improved coating properties of early water-spot resistance, hardness, ink stain blocking and scrub resistance while demonstrating the viscosity stability.

Although the following examples demonstrate the benefits of the current invention in terms of coating properties and paint stability, the examples are not meant to be limiting

### EXAMPLE 1

### Preparation of Alkyd

To a flask were charged 418 parts of pentaerythritol, 552 parts of trimethylol propane, 832 parts of isophthalic acid, 23 parts of maleic anhydride, 725 parts of benzoic acid, 1026 parts of soya fatty acid, 435 parts of dehydrated castor oil fatty acid, and 50 parts of methyl amyl ketone. The flask was equipped with water receiver and nitrogen blanketing. The temperature was raised to 230° C. while collecting water. The process continued until the acid value on solids drops below 15. The resulting resin shows the reduced viscosity at 80NV (Non-Volatile) in methyl amyl ketone of X+ Gardner-Holdt viscosity and the acid value on solids of 13.9.

### EXAMPLE 2

### Preparation of Alkyd Dispersion without Zinc Oxide Modification

To a flask were charged 500 parts of the alkyd of Example 1 and 38 parts of n-butoxy ethanol. Under nitrogen blanketing, the temperature was raised to 140° C. At this temperature, a mixture of 40 parts of vinyl toluene, 40 parts of methyl methacrylate, 50 parts of acrylic acid and 9 parts of di-t-amyl peroxide was fed into a flask over a period of 95 minutes. After the addition of monomer mixture was completed, the temperature was maintained at 140° C. for 1.5 hours then 35 parts of n-butoxy ethanol was charged into a flask. After holding the temperature at 140° C. for 20 minutes, a flask was allowed to cool. When the temperature reaches below 100° C., a mixture of 1288 parts of de-ionized water and 38 parts of aqueous ammonia (28-30%) was charged into a flask with agitation. The resulting alkyd dispersion has the viscosity of 95 poises, the NV (Non-Volatile) of 31.1, and the pH value of 8.28.

### EXAMPLE 3

### Preparation of Zinc Oxide Modified Alkyd Dispersion

To a flask were charged 500 parts of the alkyd of Example 1 and 38 parts of n-butoxy ethanol. Under nitrogen blanketing, the temperature was raised to 140° C. At this temperature, a mixture of 40 parts of vinyl toluene, 40 parts of methyl methacrylate, 50 parts of acrylic acid and 9 parts of di-t-amyl peroxide was fed into a flask over a period of 95 minutes. After the addition of monomer mixture was completed, the temperature was maintained at 140° C. for 1.5 hours then a mixture of 35 parts of n-butoxy ethanol and 7 parts of zinc oxide was charged into a flask. After holding the temperature at 140° C. for 20 minutes, a flask was allowed to cool. When the temperature reaches below 100° C., a mixture of 1288 parts of de-ionized water and 43 parts of aqueous ammonia (28-30%) was charged into a flask with agitation. The resulting alkyd dispersion has the viscosity of 88 poises, the NV (Non-Volatile) of 30.8, and the pH value of 9.11. 0.6 parts of zinc oxide was isolated after filtration of alkyd dispersion. No gellation was observed after 3 weeks at 52° C. confirming that the present invention is an effective means to incorporate ZnO into waterborne polymers.

### EXAMPLE 4

### Preparation of Alkyd

To a flask were charged 277 parts of pentaerythritol, 366 parts of trimethylol propane, 1061 parts of Pamolyn 200 (Eastman Chemicals), 463 parts of isophthalic acid and 30 parts of xylene. The flask was equipped with water receiver and nitrogen blanketing. The temperature was raised to 230° C. while collecting water. The process continued until the acid value on solids drops below 10. The resulting resin shows the reduced viscosity at 80NV (Non-Volatile) in methyl amyl ketone of V+ Gardner-Holdt viscosity and the acid value on solids of 7.8.

### EXAMPLE 5

### Preparation of Acrylic Modified Fatty Acid

To a flask were charged 1200 parts of Pamolyn 200 (Eastman Chemicals). Under nitrogen blanketing, the temperature was raised to 140° C. At this temperature, a mixture of 300 parts of vinyl toluene, 140 parts of isobutyl methacrylate, 360 parts of methacrylic acid and 24 parts of di-t-butyl peroxide was fed into a flask over a period of 4 hours. After the addition of monomer mixture was completed, the temperature was maintained at 140° C. for 1.5 hours then a flask was allowed to cool. The resulting resin shows the reduced viscosity at 60NV (Non-Volatile) in methyl amyl ketone of J+ Gardner-Holdt viscosity.

### EXAMPLE 6

### Preparation Alkyd Dispersion without Zinc Oxide Modification

To a flask were charged 400 parts of the alkyd of Example 4 and 400 parts of the acrylic modified fatty acid of Example 5. The flask was equipped with water receiver and nitrogen blanketing. The temperature was raised to 190° C. while collecting water and xylene. The process continued until the reduced viscosity at 60NV (Non-Volatile) in methyl amyl ketone reaches I-J, then the temperature was lowered. When the temperature drops to 120° C., 40 parts of n-butoxy ethanol was charged into a flask. After holding the temperature at 120° C. for 10 minutes, a flask was allowed to cool. When the temperature reaches below 100° C., a mixture of 1100 parts of de-ionized water and 40 parts of aqueous ammonia (28-30%) was charged into a flask with agitation. The resulting alkyd dispersion has the viscosity of 10.5 Pa·s (105 poises), the NV (Non-Volatile) of 39.1, and the pH value of 8.70.

### EXAMPLE 7

### Preparation of Zinc Oxide Modified Alkyd Dispersion

To a flask were charged 400 parts of the alkyd of Example 4 and 400 parts of the acrylic modified fatty acid of Example 5. The flask was equipped with water receiver and nitrogen blanketing. The temperature was raised to 190° C. while collecting water and xylene. The process continued until the reduced viscosity at 60NV (Non-Volatile) in methyl amyl ketone reaches I-J, then the temperature was lowered. When the temperature drops to 120° C., a mixture of 10 parts of zinc oxide and 40 parts of n-butoxy ethanol was charged into a flask. After holding the temperature at 120° C. for 10 minutes, a flask was allowed to cool. When the temperature reaches below 100° C., a mixture of 1100 parts of de-ionized water and 40 parts of aqueous ammonia (28-30%) was charged into a flask with agitation. The resulting alkyd dispersion has the viscosity of 8.3 Pa·s (83 poises), the NV (Non-Volatile) of 39.0, and the pH value of 8.70. No gellation was observed after 3 weeks at 52° C. confirming that the present invention is an effective means to incorporate ZnO into waterborne polymers.

### EXAMPLE 8

### Architectural Primer Using Zinc Oxide Modified Alkyd Dispersion from Example 3

An architectural primer coating was prepared using Zinc Oxide modified alkyd dispersion described in example 3. The coating was prepared following the recipe shown in Table I. A comparison primer coating was also prepared following the recipe shown in Table I but using the alkyd dispersion described in example 2.

The ingredients in the GRIND portion of the formula were mixed together under high-speed Cowles blade mixing. The Alkyd Dispersion was placed in a container of suitable size for the blend and mixed at low speed using a propeller blade. The GRIND portion was added to the mixing Alkyd Dispersion followed by the remaining ingredients in order. The resulting paint was mixed until the final ingredient was fully incorporated.

TABLE I

| Ingredient | Amount [grams] |
|---|---|
| GRIND | |
| Water | 44.9 |
| Tamol 165A (Rohm & Haas) | 12.7 |
| Triton CF-10 (Dow | 1.7 |
| Dee Fo 3010A (Munzing Chemie) | 1.7 |
| Titanium Dioxide - R706 (DuPont) | 131.9 |
| Calcium Carbonate - OMYACARB 3 (Omya Corp.) | 113.1 |
| LETDOWN | |
| Alkyd Dispersion | 719.2 |
| Water | 7.0 |
| Rheolate 350 (Elementis) | 2.3 |

Physical properties for the formula in Table I are specific weight of 1.23 g/ml (10.3 pounds per gallon), non-volatile material by weight 46%, non-volatile material by volume 33%, and pigment volume concentration of 27%.

The two resulting primers were compared for ink stainblocking characteristics using the following practice. First, a basecoat of acrylic latex interior flat white paint was applied to a sealed white paint test chart using a #36 wire wound rod to have around 0.076 mm wet film thickness. After drying, ink stains were applied to the surface using Marks-A-Lot solvent-based ink markers (black, green, and red), Crayola water-based ink markers (black, green, and red), and blue Papermate ball point ink pen. The ink stains were applied in consecutive lines using a straight edge across the length of the test chart such that each new line touched the previous line above resulting in a covered area 10-15 mm in height. The ink stains were allowed to dry for 14 hours. Two primer coatings were then applied side by side perpendicular to the direction of the ink stain lines using a 0.076 mm (3 mils) Bird drawdown bar. After 2 hours of drying, a topcoat of interior semi-gloss acrylic latex white paint was applied using a 3-mil Bird drawdown bar parallel to the direction of the ink stain lines. CIELab color measurements were read on each ink stain area using a spectrophotometer with settings of Small Area View, D65 illuminant, and excluding the spectral component of gloss.

ΔE's were calculated between the two primer samples for each ink type and color. The results were averaged using the following formula:

$$\frac{\begin{matrix}\sum ( Δ E advantage for ZnO modified ) - \\ \sum ( Δ E advantage for conventional alkyd dispersion ) \end{matrix}}{Total Number of ink stains}$$

Five of the seven ink stains evaluated showed advantage for the ZnO modified alkyd dispersion example. The benefit for the Zinc Oxide modified Alkyd Dispersion calculated from the formula in Table III shows a 1.2 ΔE improvement in ink stainblocking for the ZnO-modified alkyd dispersion described in Example 3 over the conventional alkyd dispersion described in Example 2.

Stability characteristics of the architectural primer coating formulas were compared in an elevated temperature environment. 0.18-0.24 l (6-8 fluid ounces) of each sample were placed in sealed half-pint containers and placed in a 52° C. oven chamber for a two week period. Samples were observed for settling after 1 and 2 weeks in the 52° C. environment. The sample using the ZnO-modified alkyd dispersion from example 3 showed no settling after two weeks. The samples using the conventional alkyd dispersion from example 2 both with and without Zinc Oxide modification showed slight soft settling (thin layer of settled material that could not be stirred into the paint) after two weeks.

### EXAMPLE 9

### Architectural Gloss Paint Using Zinc Oxide Modified Alkyd Dispersion from Example 3

An architectural gloss paint was prepared using Zinc Oxide modified alkyd dispersion described in example 3. The coating was prepared following the recipe shown in Table II. This composition was then compared for scrub resistance, hardness, and early water resistance versus the same coating recipe using the alkyd dispersion described in example 2.

The ingredients in the GRIND portion of the formula were mixed together under high-speed Cowles blade mixing. The Alkyd Dispersion was placed in a container of suitable size for the blend and mixed at low speed using a propeller blade. The GRIND portion was added to the mixing Alkyd Dispersion followed by the remaining ingredients in order. The resulting paint was mixed until the final ingredient was fully incorporated.

TABLE II

| Ingredient | Amount [grams] |
|---|---|
| GRIND | |
| Water | 57.2 |
| BYK 035 (BYK Chemie) | 0.9 |
| Surfynol CT131 (Air Products) | 13.0 |
| Bentone EW (Elementis) | 1.8 |
| AMP-95 (Dow) | 0.3 |
| Titanium Dioxide - R706 (DuPont) | 209.9 |
| MINEX 10 (Unimin) | 35.7 |
| LETDOWN | |
| Alkyd Dispersion | 712.5 |
| Dee Fo 215 (Munzing Chemie) | 1.9 |
| Co Hydrocure II (OMG) | 5.4 |
| Rheolate 350 (Elementis) | 5.2 |

Physical properties for the formula in Table II are specific weight of 1.25 g/ml (10.4 pounds per gallon), non-volatile material by weight 46%, non-volatile material by volume 33%, and pigment volume concentration of 25%.

Table III lists gloss and film performance from evaluations between the Zinc Oxide modified and conventional alkyd dispersion paints made using the recipe shown in Table II.

TABLE III

| | | Alkyd Dispersion and Type | |
|---|---|---|---|
| | | Example 2 | Example 3 |
| Test | Standard Method | Conventional | ZnO Modified |
| Gloss | ASTM D52 | | |
| 20 deg. View Angle | | 31 | 43 |
| 60 deg. View Angle | | 70 | 76 |
| Sward Hardness | ASTM D2134 | | |
| [cycles] | | | |
| 3-Day Air Dry | | 13 | 21 |
| 7-Day Air Dry | | 19 | 28 |
| Scrub Resistance | ASTM D2486, | 183 | 213 |
| [cycles] | method B | | |
| Water Resistance | ASTM D1308 | | |
| 2-Hour Air Dry | | 2 | 4 |
| 5-Hour Air Dry | | 3 | 6 |

The Water Resistance test was conducted using a covered spot test with 10 minutes of contact time. The result was assigned a rating of 0-10 with 0 being poor performance resulting in severe defects to the paint film and 10 being excellent performance or no effect on the paint film.

Stability characteristics of the gloss paint coating formulas were compared in an elevated temperature environment. 170-227 grams (6-8 fluid ounces) of each sample were placed in sealed half-pint containers and placed in a 52° C. oven chamber for a two week period. Samples were observed for settling after 1 and 2 weeks in the 52° C. environment. The samples using the alkyd dispersions from example 2 (conventional dispersion) and example 3 (zinc oxide-modified dispersion) showed no settling after two weeks. The sample made with the alkyd dispersion from example 2 and with Zinc Oxide added into the GRIND portion of the gloss paint formula showed slight soft settling (thin layer of settled material that could not be stirred into the paint) after 1 week with no improvement or degradation after 2 weeks.

### EXAMPLE 10

### Architectural Primer Using Zinc Oxide Modified Alkyd Dispersion from Example 7

An architectural primer coating was prepared using Zinc Oxide modified alkyd dispersion described in example 7. The coating was prepared following the recipe shown in Table IV. A comparison primer coating was also prepared following the recipe shown in Table IV but using the alkyd dispersion described in example 6.

The ingredients in the GRIND portion of the formula were mixed together under high-speed Cowles blade mixing. The Alkyd Dispersion was placed in a container of suitable size for the blend and mixed at low speed using a propeller blade. The GRIND portion was added to the mixing Alkyd Dispersion followed by the remaining ingredients in order. The resulting paint was mixed until the final ingredient was fully incorporated.

TABLE IV

| Ingredient | Amount [grams] |
|---|---|
| GRIND | |
| Water | 43.1 |
| Tamol 165A (Rohm & Haas) | 12.2 |
| Triton CF-10 (Dow) | 1.6 |
| Dee Fo 3010A (Munzing Chemie) | 1.6 |
| Titanium Dioxide - R706 (DuPont) | 126.5 |
| Calcium Carbonate - OMYACARB 3 (Omya Corp.) | 108.5 |
| LETDOWN | |
| Alkyd Dispersion | 550.3 |
| Co Hydrocure II (OMG) | 5.3 |
| Water | 146.4 |
| Rheolate 350 (Elementis) | 25.0 |

Physical properties for the formula in Table IV are specific weight of 1.22 g/ml (10.2 pounds per gallon), non-volatile material by weight 46%, non-volatile material by volume 34%, and pigment volume concentration of 25%.

The two resulting primers were compared for ink stainblocking characteristics using the practice described in Example 8. Seven of the seven ink stains evaluated showed advantage for the ZnO modified alkyd dispersion example. The benefit for the Zinc Oxide modified Alkyd Dispersion calculated from the formula above shows a 7.3 ΔE improvement in ink stainblocking for the ZnO-modified alkyd dispersion described in Example 7 over the conventional alkyd dispersion described in Example 6.

Stability characteristics of the architectural primer coating formulas were compared in an elevated temperature environment. 6-8 fluid ounces of each sample were placed in sealed half-pint containers and placed in a 52° C. oven chamber for a two week period. Samples were observed for settling after 1 and 2 weeks in the 52° C. environment. The sample using the ZnO-modified alkyd dispersion from example 7 showed no settling after two weeks. The sample using the conventional alkyd dispersion described in example 6 but no added Zinc Oxide in the coating formulation passed after one week but showed soft settling of 1.27-2.54 cm (½-1 inch) in depth that could not be completely reincorporated by stirring after 2 weeks. The sample with Zinc Oxide added into the GRIND portion of the formula showed hard settling after 1 week.

### EXAMPLE 11

### Architectural Gloss Paint Using Zinc Oxide Modified Alkyd Dispersion from Example 7

An architectural gloss paint was prepared using Zinc Oxide modified alkyd dispersion described in example 7. The coating was prepared following the recipe shown in Table V. This composition was then compared for scrub resistance, hardness, and early water resistance versus the same coating recipe using the alkyd dispersion described in example 6.

The ingredients in the GRIND portion of the formula were mixed together under high-speed Cowles blade mixing. The Alkyd Dispersion was placed in a container of suitable size for the blend and mixed at low speed using a propeller blade. The GRIND portion was added to the mixing Alkyd Dispersion followed by the remaining ingredients in order. The resulting paint was mixed until the final ingredient was fully incorporated.

TABLE V

| Ingredient | Amount [grams] |
|---|---|
| GRIND | |
| Water | 57.2 |
| BYK 035 (BYK Chemie) | 0.9 |
| Surfynol CT131 (Air Products) | 13.0 |
| Bentone EW (Elementis) | 1.8 |
| AMP-95 (Dow) | 0.3 |
| Titanium Dioxide - R706 (DuPont) | 209.9 |
| MINEX 10 (Unimin) | 35.7 |
| LETDOWN | |
| Alkyd Dispersion | 712.5 |
| Dee Fo 215 (Munzing Chemie) | 1.9 |
| Co Hydrocure II (OMG) | 5.4 |
| Rheolate 350 (Elementis) | 5.2 |

Physical properties for the formula in Table V are weight per gallon of 10.7 pounds, non-volatile material by weight 52%, non-volatile material by volume 38%, and pigment volume concentration of 24%.

Table VI lists gloss and film performance from evaluations between the Zinc Oxide modified and conventional alkyd dispersion paints made using the recipe shown in Table V.

TABLE VI

| | | Alkyd Dispersion and Type | |
|---|---|---|---|
| | | Example 2 | Example 3 |
| Test | Standard Method | Conventional | ZnO Modified |
| Gloss | ASTM D523 | | |
| 20 deg. View Angle | | 63 | 52 |
| 60 deg. View Angle | | 81 | 81 |
| Sward Hardness | ASTM D2134 | | |
| [cycles] | | | |
| 3-Day Air Dry | | 12 | 19 |
| 7-Day Air Dry | | 13 | 23 |
| Scrub Resistance | ASTM D2486, | 465 | 590 |
| [cycles] | method B | | |
| Water Resistance | ASTM D1308 | | |
| 2-Hour Air Dry | | 8 | 9 |
| 5-Hour Air Dry | | 9 | 10 |

The Water Resistance test was conducted using a covered spot test with 10 minutes of contact time. The result was assigned a rating of 0-10 with 0 being poor performance resulting in severe defects to the paint film and 10 being excellent performance or no effect on the paint film.

Stability characteristics of the gloss paint coating formulas were compared in an elevated temperature environment. 0.18-0.24 l (6-8 fluid ounces) of each sample was placed in sealed half-pint containers and placed in a 52° C. oven chamber for a two week period. Samples were observed for settling after 1 and 2 weeks in the 52° C. environment. The samples using the alkyd dispersions from example 6 (conventional dispersion) and example 7 (zinc oxide-modified dispersion) showed no settling after two weeks. The sample made with the alkyd dispersion from example 6 and Zinc Oxide added into the GRIND portion of the gloss paint formula showed slight soft settling (thin layer of settled material that could not be stirred into the paint) after 1 week with no improvement or degradation after 2 weeks.

We claim:

1. A composition comprising acrylic-modified alkyd and at least 0.1 and up to 5 weight percent of a zinc compound.

2. The acrylic-modified alkyd composition according to claim 1, wherein it is produced by mixing the acrylic modified alkyd and the zinc compound at elevated temperatures of higher than 50° C.

3. The acrylic-modified alkyd composition according to claim 1, wherein the acrylic modified alkyd is produced by the condensation reaction of an alkyd with acrylic-modified fatty acid(s).

4. The acrylic-modified alkyd composition according to claim 3, wherein, the acrylic-modified fatty acid(s) is produced by the radical polymerization of at least one ethylenically unsaturated monomer and of at least one carboxy-containing ethylenically unsaturated monomer at a temperature of 60-220° C.

5. The acrylic-modified alkyd composition according to claim 1 wherein it is produced by the radical polymerization of at least one ethylenically unsaturated monomer and at least one carboxy-containing ethylenically unsaturated monomer at the temperatures of 60-220° C. in the presence of an alkyd.

6. The acrylic-modified alkyd composition according to claim 3 wherein the alkyd is produced by the condensation reaction of multifunctional acid compound(s) and/or monofunctional acid compound(s) and multifunctional hydroxyl compound(s) and fatty acid(s) and/or oil(s).

7. The acrylic-modified alkyd composition according to claim 1, wherein it comprises between 5 to 95 weight percent of an alkyd.

8. The acrylic-modified alkyd composition according to claims 1, wherein the zinc compound is selected from zinc oxide, zinc nitrophthalate, zinc acetate, zinc fluoride, zinc molybdate, zinc linoleate, zinc naphthenate, zinc palmitate, and zinc stearate.

9. An aqueous polymer dispersion, wherein it is produced by salt formation between a base and the acrylic-modified alkyd composition of claim 1 comprising at least 0.1 weight percent of the said zinc compound.

10. An aqueous polymer dispersion according to claim 9, wherein the base is selected from aqueous ammonia, triethyl amine, n-methyl morpholine, sodium hydroxide, lithium hydroxide, lithium hydroxide monohydrate, and n,n-dimethyl ethanol amine.

11. The aqueous dispersion according to claim 10, wherein it has a non-volatile content of 20 to 60 percent by weight.

12. A coating composition, wherein it comprises an aqueous dispersion as defined in claim 9.

13. An ink composition, wherein it comprises an aqueous dispersion as defined in claim 9.

14. An adhesive composition, wherein it comprises an aqueous dispersion as defined in claim 9.
